(19) United States
(12) Patent Application Publication
(10) Pub. No.: US 2013/0040262 A1
(43) Pub. Date: Feb. 14, 2013

(54) Removing Primary Teeth And Loosening Permanent Teeth

(71) Applicants: James Jiwen Chun, Raleigh, NC (US); Jennifer Miseong Chun, Raleigh, NC (US); Angela Soyoung Chun, Raleigh, NC (US); Andrew Youngho Chun, Raleigh, NC (US)

(72) Inventors: James Jiwen Chun, Raleigh, NC (US); Jennifer Miseong Chun, Raleigh, NC (US); Angela Soyoung Chun, Raleigh, NC (US); Andrew Youngho Chun, Raleigh, NC (US)

(73) Assignee: Hankookin, LLC

(21) Appl. No.: 13/568,573

(22) Filed: Aug. 7, 2012

Related U.S. Application Data
(60) Provisional application No. 61/521,124, filed on Aug. 8, 2011.

(51) Int. Cl. A61C 3/14; A61C 1/07

(52) U.S. Cl. 433/118; 433/215

(57) ABSTRACT

A method and apparatus for rupturing connective tissues that attach a tooth to a patient's alveolar bone socket are provided. The apparatus includes a metal cap removably attached to the tooth using a cementing agent, and a transducer assembly having a transducer head and a ball projection. The metal cap includes a body section having a hollow space defined by its coronal surface and contiguous vertical surfaces for enclosing the tooth. The body section has a slit terminating with an apical strip and loop arrangement. The metal cap further includes a ball socket extending from the coronal surface of the body section. The transducer head generates vibrational and tapping movements in the ball projection. The ball projection operatively engages the ball socket to transfer the vibrational and tapping movements to the metal cap and thereby to the tooth, which ruptures the connective tissues of the tooth.

### CROSS REFERENCE TO RELATED APPLICATIONS

This application claims the benefit of provisional patent application No. 61/521,124 titled “Home Device to Remove Primary and Loosen Permanent Teeth”, filed in the United States Patent and Trademark Office on Aug. 8, 2011.

The specification of the above referenced patent application is incorporated herein by reference in its entirety.

### BACKGROUND

Every child goes through a process of losing primary teeth or baby teeth that are replaced by permanent teeth as the child grows up. In most cases, when the child begins losing the primary teeth, even though the primary teeth begin to loosen, the connective ligaments are still attached to the roots of the primary teeth. It may take weeks before the primary teeth eventually fall out which causes significant discomfort to the child during the teeth replacement period. Apart from going to a dentist, there has not been an effective, painless home technique or apparatus that can be used to remove the primary teeth without causing significant discomfort to the child.

Conventional methods and devices for extracting teeth typically use strong torque and pulling forces to dislodge a root of a tooth from a bone socket. These extraction procedures cause pain, bleeding, and trauma to the surrounding gingival and bone structures. Although dentists use local anesthetics to reduce the pain and discomfort during the extraction procedure, many children are still afraid of going to the dentist to have their primary teeth removed due to the fear and anxiety of pain and discomfort involved in the extraction procedure.

Hence, there is a long felt but unresolved need for a method and an apparatus that ruptures connective tissues that attach a tooth to an alveolar bone socket of a patient to allow the tooth to be dislodged from the alveolar bone socket while causing minimal pain and discomfort to the patient.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and apparatus disclosed herein address the above stated need for rupturing connective tissues that attach a tooth to an alveolar bone socket of a patient, and as a result allow the tooth to be dislodged from the alveolar bone socket with minimal pain and discomfort to the patient. The apparatus disclosed herein comprises a metal cap generally shaped like a crown of the tooth, and a transducer assembly. The metal cap is removably attached to the tooth using a cementing agent. The cementing agent comprises a rigid, biologically safe, and quick setting dental cement that secures the metal cap firmly to the tooth.

The metal cap comprises a body section and a ball socket. The body section of the metal cap comprises a coronal surface and multiple generally contiguous vertical surfaces that define a hollow space within the body section for enclosing the tooth. The generally contiguous vertical surfaces are closed surfaces. The metal cap is, for example, made of a soft metal alloy or a rigid metal, and shaped to custom fit each type of primary teeth up to a gum line of the patient. In an embodiment, the length of the generally contiguous vertical surfaces of the body section of the metal cap is configured to enclose half a length of the tooth towards a gum line of the patient, when the metal cap is removably attached to the tooth. In this embodiment, the metal cap is made of a rigid metal, for example, stainless steel. Enclosing only the top half of the tooth enables easy removal of the metal cap at the end of the procedure.

The generally contiguous vertical surfaces of the body section of the metal cap comprise, for example, a buccal surface, a lingual surface, and a pair of opposing inter-tooth surfaces. In an embodiment, the buccal surface and the lingual surface are configured to enclose the tooth up to the gum line of the patient, when the metal cap is removably attached to the tooth, while the opposing inter-tooth surfaces are shaped or clipped to enclose the tooth at half the distance above contact points with adjacent teeth. As used herein, the term “buccal” refers to a direction towards the inside of a cheek and/or lips of the patient, and all elements or components characterized by this term are disposed towards or proximal to the cheek and/or the lips. Also, as used herein, the term “lingual” refers to a direction towards the tongue of the patient, and all elements or components characterized by this term are disposed towards or proximal to the tongue. A dental cement can be used to fasten the metal cap to the tooth. The buccal surface and the lingual surface of the metal cap can be fastened to the body of the tooth with dental forceps before the cement sets hard.

At least one of the generally contiguous vertical surfaces is folded and comprises a slit terminating with an apical strip and loop arrangement. As used herein, the term “apical” refers to a direction towards the root of a tooth, and all elements or components characterized by this term are disposed towards or proximal to the root of the tooth. The apical strip and loop arrangement of the body section of the metal cap secures the metal cap to the tooth. The apical strip and loop arrangement is severed open to remove the metal cap from the tooth. In an embodiment, the apical strip and loop arrangement of the body section of the metal cap is configured as a fold in an apical edge of the body section. The apical edge is soldered at a neck of the fold to form a seal. The soldered seal can be severed, for example, using a specially designed scissor, or a finger nail clipper to remove the metal cap from the tooth.

The ball socket of the metal cap extends from the coronal surface of the body section. In an embodiment, the ball socket is an enclosed shell that produces a pull force to pull the tooth vertically from the alveolar bone socket. The ball projection is inserted into the ball socket from the side and locked inside the ball socket. This type of metal cap is made, for example, using stainless steel, and can be sterilized for reuse.

The transducer assembly of the apparatus disclosed herein comprises a transducer head and a ball projection extending from the transducer head. The ball projection extends from the transducer head, for example, in a linear configuration, a curved configuration, an angled configuration, etc. The transducer head is configured to generate vibrational and tapping movements in the ball projection at a predetermined frequency which causes minimal pain and discomfort to the patient. During a tooth removal procedure or a tooth loosening procedure, the ball projection of the transducer assembly is configured to operatively engage the ball socket of the metal cap to transfer the generated vibrational and tapping movements to the removably attached metal cap and thereby to the tooth. The vibrational and tapping movements transferred to the tooth by the transducer assembly rupture the connective tissues that attach the tooth to the alveolar bone socket of the patient to allow the tooth to be dislodged or removed from the alveolar bone socket.

Also, disclosed herein is a method for rupturing connective tissues that attach a tooth to an alveolar bone socket of a patient. The metal cap and the transducer assembly of the apparatus disclosed herein are provided. The metal cap is removably attached to the tooth using a cementing agent. The transducer head of the transducer assembly generates vibrational and tapping movements in the ball projection at a predetermined frequency. The ball projection of the transducer assembly operatively engages with the ball socket of the removably attached metal cap for transferring the generated vibrational and tapping movements to the removably attached metal cap and thereby to the tooth. The vibrational and tapping movements transferred to the tooth by the transducer assembly ruptures the connective tissues that attach the tooth to the alveolar bone socket of the patient, thereby allowing the tooth to be readily removed from the alveolar bone socket with minimal force.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1A illustrates a disassembled view of an apparatus for rupturing connective tissues that attach a tooth to an alveolar bone socket of a patient.

FIG. 1B exemplarily illustrates an assembled view of the apparatus for rupturing connective tissues that attach a tooth to an alveolar bone socket of a patient.

FIG. 2A exemplarily illustrates a bottom perspective view of a metal cap of the apparatus.

FIG. 2B exemplarily illustrates a side elevation view of the metal cap.

FIG. 2C exemplarily illustrates a front elevation view of the metal cap.

FIG. 3A exemplarily illustrates a bottom perspective view of an embodiment of the metal cap.

FIG. 3B exemplarily illustrates a side elevation view of the embodiment of the metal cap.

FIG. 3C exemplarily illustrates a front elevation view of the embodiment of the metal cap.

FIG. 4A exemplarily illustrates a bottom perspective view of another embodiment of the metal cap.

FIG. 4B exemplarily illustrates a side elevation view of the embodiment of the metal cap.

FIG. 4C illustrates a front elevation view of the embodiment of the metal cap.

FIG. 5A exemplarily illustrates a partial perspective view of an embodiment of a ball socket of the metal cap.

FIG. 5B exemplarily illustrates a partial front elevation view of the embodiment of the ball socket of the metal cap.

FIG. 5C exemplarily illustrates a partial side elevation view of the embodiment of the ball socket of the metal cap.

FIG. 5D exemplarily illustrates a top view of the embodiment of the ball socket of the metal cap.

FIG. 6A exemplarily illustrates a side view of a transducer assembly of the apparatus, showing a ball projection extending from a transducer head of the transducer assembly in a linear configuration.

FIG. 6B exemplarily illustrates a side view of a transducer assembly of the apparatus, showing a ball projection extending from a transducer head of the transducer assembly in a curved configuration.

FIG. 6C exemplarily illustrates a side view of a transducer assembly of the apparatus, showing a ball projection extending from a transducer head of the transducer assembly in an angled configuration.

FIG. 7 illustrates a method for rupturing connective tissues that attach a tooth to an alveolar bone socket of a patient.

FIG. 8 exemplarily illustrates application of a cementing agent on a tooth using a mixing syringe.

### DETAILED DESCRIPTION OF THE INVENTION

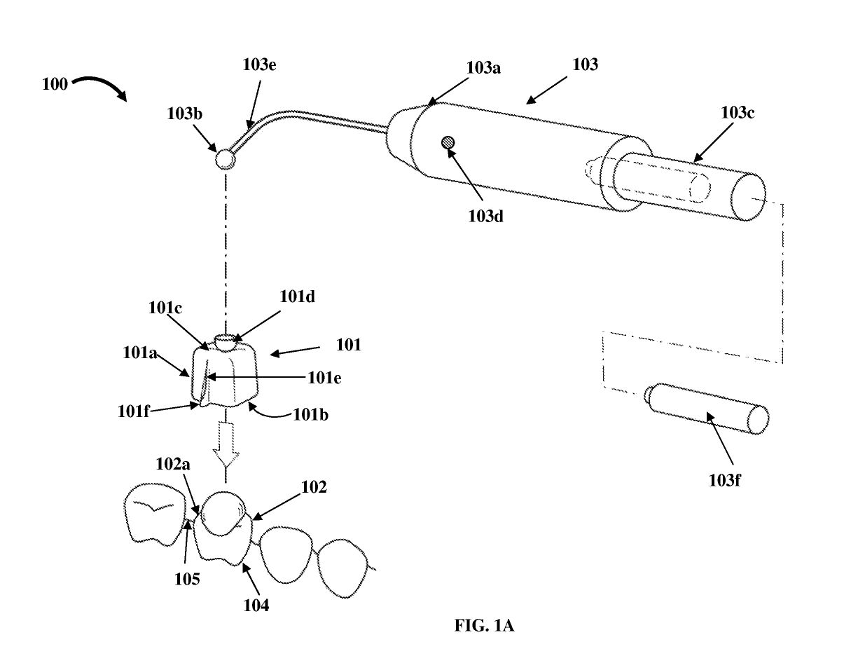

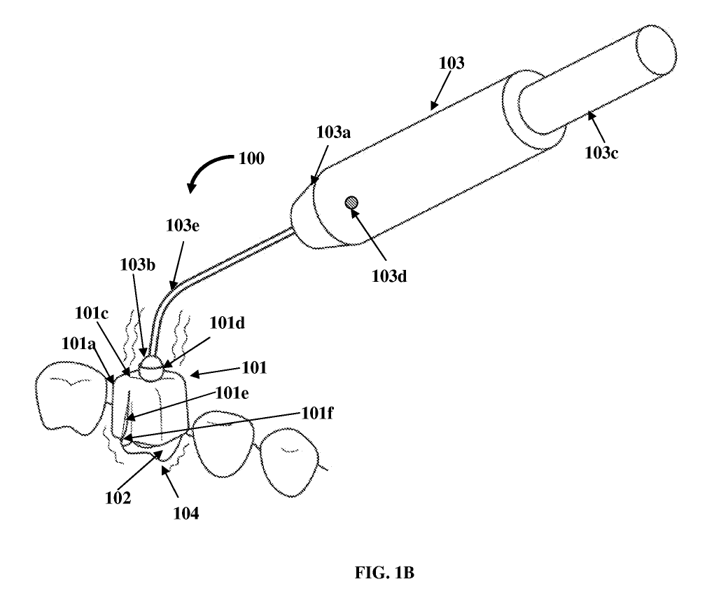

FIG. 1A illustrates a dissembled view of an apparatus 100 for rupturing connective tissues that attach a tooth 102 to an alveolar bone socket 104 of a patient. FIG. 1B exemplarily illustrates an assembled view of the apparatus 100 for rupturing the connective tissues that attach a tooth 102 to the alveolar bone socket 104 of the patient. The apparatus 100 disclosed herein ruptures the connective tissues, for example, periodontal ligaments that attach the tooth 102 to the alveolar bone socket 104, and as a result allow the tooth 102 to be readily dislodged from the alveolar bone socket 104 with minimal pain and discomfort to the patient. The apparatus 100 disclosed herein comprises a metal cap 101 generally shaped like a crown 102a of the tooth 102, and a transducer assembly 103. The metal cap 101 is removably attached to the tooth 102 using a cementing agent. The cementing agent comprises a rigid, biologically safe, and quick setting dental cement that secures the metal cap 101 firmly to the tooth 102. The cementing agent is, for example, the Zone translucent temporary dental cement manufactured by Dux Dental® of Dux Industries, Inc.

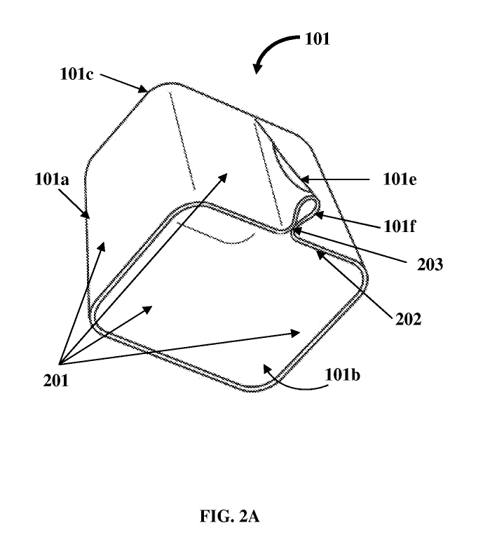

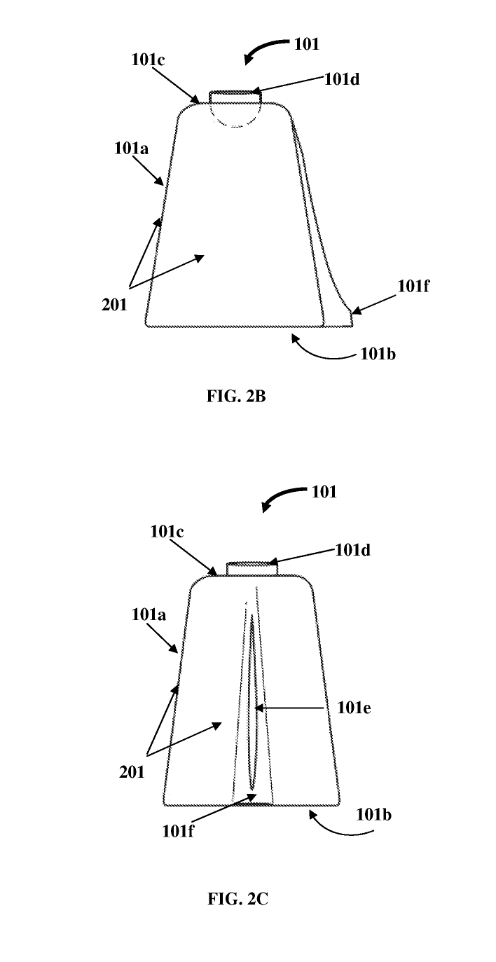

The metal cap 101 comprises a generally rectangular body section 101a. The body section 101a comprises a coronal surface 101c and multiple generally contiguous vertical surfaces 201 that define a hollow space 101b within the body section 101a for enclosing the tooth 102, as exemplarily illustrated in FIGS. 2A-2C. As used herein, the term “coronal” refers to a direction towards the crown 102a of a tooth 102, and all elements or components characterized by this term are disposed towards or proximal to the crown 102a of the tooth 102. The generally contiguous vertical surfaces 201 are closed surfaces. FIG. 2A exemplarily illustrates a bottom perspective view of the metal cap 101. FIG. 2B exemplarily illustrates a side elevation view of the metal cap 101. FIG. 2C exemplarily illustrates a front elevation view of the metal cap 101. At least one of the generally contiguous vertical surfaces 201 is folded and comprises a slit 101e terminating with an apical strip and loop arrangement 101f. As used herein, the term “apical” refers to a direction towards the root of a tooth 102, and all elements or components characterized by this term are disposed towards or proximal to the root of the tooth 102. The metal cap 101 further comprises a ball socket 101d extending from the coronal surface 101c of the body section 101a. The metal cap 101 is made of a soft metal alloy, for example, containing aluminum, or a rigid metal, and shaped to custom fit each type of primary teeth 102 up to a gum line 105 of the patient.

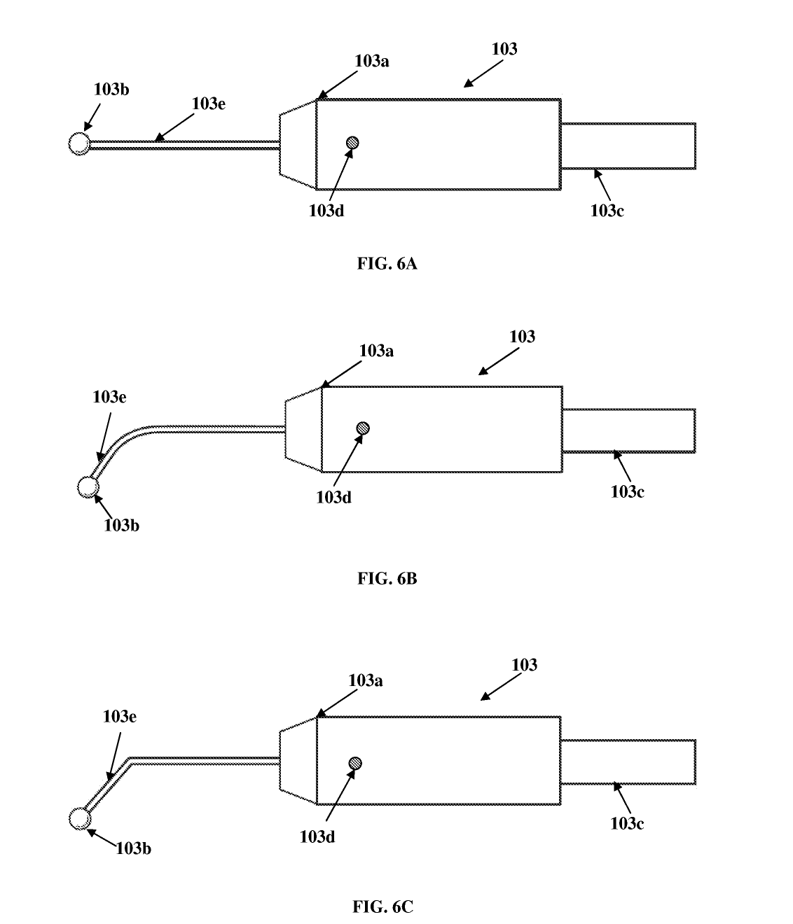

As exemplarily illustrated in FIGS. 1A-1B, the transducer assembly 103 of the apparatus 100 disclosed herein comprises a transducer head 103a, a ball projection 103b extending from the transducer head 103a, and a battery compartment 103c that stores a battery 103f. The battery 103f powers the transducer head 103a. The ball projection 103b extends from the transducer head 103a, for example, in a linear configuration as exemplarily illustrated in FIG. 6A, a curved configuration as exemplarily illustrated in FIG. 6B, or an angled configuration as exemplarily illustrated in FIG. 6C. The transducer head 103a is configured to generate vibrational and tapping movements in the ball projection 103b, the amplitude and frequency of which can be varied. During a tooth removal procedure or a tooth loosening procedure, the ball projection 103b is configured to operatively engage the ball socket 101d of the metal cap 101 through the neck 103e of the ball projection 103b to transfer the generated vibrational and tapping movements to the removably attached metal cap 101 and thereby to the tooth 102 enclosed by the metal cap 101. The vibrational and tapping movements transferred to the tooth 102 by the transducer assembly 103 ruptures the connective tissues that attach the tooth 102 to the alveolar bone socket 104 of the patient to allow the tooth 102 to be removed from the alveolar bone socket 104. In an embodiment, the transducer assembly 103 is configured to generate the vibrational and tapping movements at a predetermined frequency which causes minimal pain and discomfort to the patient.

The transducer head 103a of the transducer assembly 103 is configured to produce acoustic vibrations or ultrasonic vibrations. In an embodiment, the transducer head 103a is configured with a magnetostrictive transducer that applies a property of magnetostriction for producing acoustic vibrations. Magnetostriction utilizes the property of ferromagnetic materials, for example, iron, nickel, cobalt, etc., and their alloys, that causes them to change their physical properties during the process of magnetization. The magnetostriction transducer converts magnetic energy into kinetic energy and vice versa, and creates the acoustic vibrations.

In another embodiment, the transducer head 103a is configured with a piezoelectric transducer that produces acoustic vibrations or ultrasonic vibrations. Electrostriction is a property of electrical non-conductors or dielectrics, for example, lead magnesium niobate, lead magnesium niobate-lead titanate, lead lanthanum zirconate titanate, etc., that causes them to change their physical properties under the application of an electric field. The piezoelectric transducer utilizes a converse piezoelectric effect of dielectrics and converts electrical energy to acoustic energy and vice versa.

The transducer assembly 103 disclosed herein configured as a magnetostrictive transducer or a piezoelectric transducer produces vibrations with an acoustic range of, for example, about 20 Hz to about 20 kHz and an ultrasonic range of about 20 kHz to about 45 kHz. To avoid heat buildup during vibration, intervals are built in between the pulses of vibrations. The transducers that may be used in the transducer head 103a include, for example, transducers operating with an optimum frequency of about 516 Hz that are used in electric toothbrushes, transducers operating with an optimum frequency in a range of about 25 kHz to about 35 kHz that are used in dental ultrasonic scalers such as the TurboPIEZO™ ultrasonic scaler of Parkell, Inc., etc. In an example, the transducer which operates at a frequency of about 516 Hz used in the Sonicare® toothbrush of Koninklijke Philips Electronics N.V. Limited Liability Company, Netherlands may be used in the transducer head 103a of the transducer assembly 103. This transducer produces vibrations that can be transferred to the metal cap 101 without causing an unpleasant sensation to the gum or the tooth 102 enclosed by the metal cap 101.

Although the detailed description refers to the transducer head 103a configured with a magnetostrictive transducer or a piezoelectric transducer; the scope of the apparatus 100 disclosed herein is not limited to a magnetostrictive transducer or a piezoelectric transducer but may be extended to include other transducers that produce vibrations, for example, sonic transducers, ultrasonic transducers, etc., and other functionally equivalent transducers.

The apparatus 100 disclosed herein is used to extract a primary tooth 102 when the primary tooth 102 begins to loosen. The transducer assembly 103 is configured to produce a multitude of vibrational movements per second, and the small amount of force transferred to the ball socket 101d of the metal cap 101 is generally sufficient to rupture the connective tissues, for example, periodontal ligaments. For example, if the transducer assembly 103 produces vibrations up to a supersonic frequency of, for example, about 5 kHz to about 35 kHz, the periodontal ligaments are ruptured in a few seconds, and the tooth 102 can be readily removed from the alveolar bone socket 104 with minimal trauma and pain. The apparatus 100 disclosed herein is configured to produce a combination of high frequency vibrational and tapping movements on the tooth 102 to be extracted. These movements are directed downward and sideways around the root of the tooth 102 and correspond to forces that the tooth 102 encounters during normal chewing. These high frequency vibrational and tapping movements cause minimal pain to a patient. The magnitude of the forces applied by the apparatus 100 disclosed herein is light and the frequency of the forces is high such that these forces and the corresponding movement directed downward and sideways around the root of the tooth 102 cause minimal discomfort to the patient.

FIGS. 2A-2C exemplarily illustrate different views of the metal cap 101. The shape of the metal cap 101 conforms to the anatomy of the tooth 102, and the hollow space 101b of the metal cap 101 is slightly bigger than the tooth 102 to be extracted to allow the metal cap 101 to fit over the tooth 102. The metal cap 101 is cemented to the tooth 102 and encloses the tooth 102 down to the gum line 105. The method of applying the cementing agent to the tooth 102 is disclosed in the detailed description of FIG. 8. In an example, the cementing agent is applied on the inner surfaces of the metal cap 101 and to the crown 102a of the tooth 102, and thereafter the metal cap 101 is positioned and fitted over and around the tooth 102.

The apical strip and loop arrangement 101f of the body section 101a of the metal cap 101 also secures the metal cap 101 to the tooth 102. In an embodiment, one of the generally contiguous vertical surfaces 201 of the metal cap 101 has a partially-opened frontal opening or slit 101e and is secured by the apical strip and loop arrangement 101f. The apical strip and loop arrangement 101f can be severed to open up the frontal slit 101e for removing the metal cap 101 from the tooth 102. In an embodiment, the apical strip and loop arrangement 101f of the body section 101a of the metal cap 101 is configured as a fold in an apical edge 202 of the body section 101a. The apical edge 202 of the body section 101a is soldered at a neck of the fold to form a seal 203. The soldered seal 203 is not very rigid and if the apical strip and loop arrangement 101f is cut open, for example, by a finger nail clipper, the soldered seal 203 becomes loose and the frontal slit 101e opens up, enabling easy removal of the metal cap 101 from the tooth 102. The soldered seal 203 can be severed, for example, using a specially designed scissor or a finger nail clipper to remove the metal cap 101 from the tooth 102.

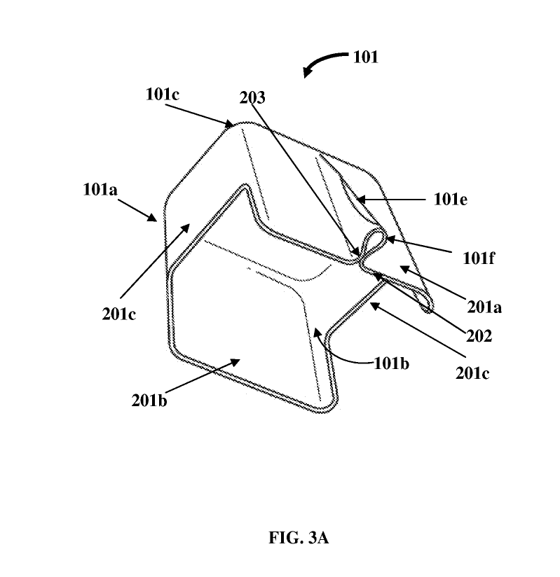

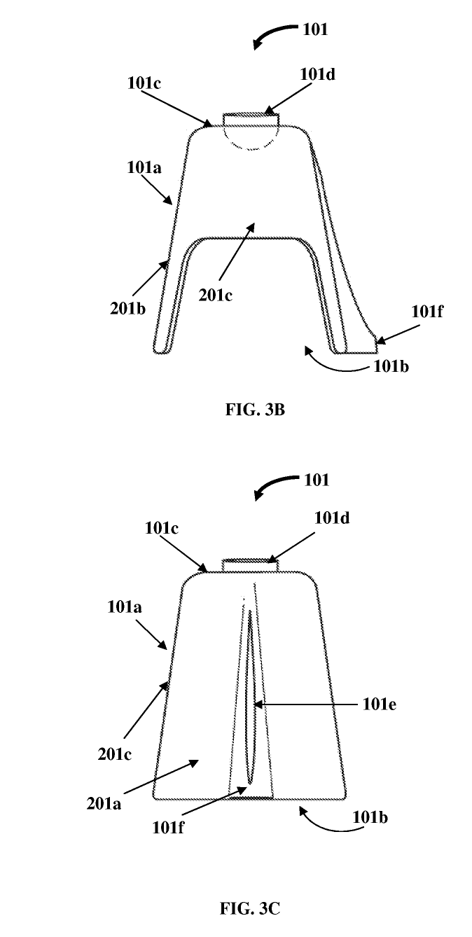

FIG. 3A exemplarily illustrates a bottom perspective view of an embodiment of the metal cap 101. FIG. 3B exemplarily illustrates a side elevation view of the embodiment of the metal cap 101. FIG. 3C exemplarily illustrates a front elevation view of the embodiment of the metal cap 101. The apparatus 100 disclosed herein can also allow dentists to loosen a permanent tooth 102, although a stronger vibrational force may be required to be applied by the apparatus 100 disclosed herein to rupture the connective tissues and allow the permanent tooth 102 to be dislodged and removed. Since stronger forces are required to remove a permanent tooth 102, the material of the metal cap 101 used to remove the permanent tooth 102 comprises a rigid metal, for example, stainless steel. Furthermore, permanent teeth 102 are generally not as loose and movable as primary teeth 102, and hence it is difficult to force fit the metal cap 101 between the permanent teeth 101. The metal cap 101 as exemplarily illustrated in FIGS. 3A-3C is used to remove permanent teeth 102. The generally contiguous vertical surfaces 201 of the body section 101a of the metal cap 101 comprise, for example, a buccal surface 201b, a lingual surface 201a, and a pair of opposing inter-tooth surfaces 201c. As used herein, the term “buccal” refers to a direction towards the inside of a cheek and/or lips of the patient, and all elements or components characterized by this term are disposed towards or proximal to the cheek and/or the lips. Also as used herein, the term “lingual” refers to a direction towards the tongue of the patient, and all elements or components characterized by this term are disposed towards or proximal to the tongue.

In this embodiment, the buccal surface 201b and the lingual surface 201a are configured to enclose the permanent tooth 102 up to the gum line 105 of the patient when the metal cap 101 is removably attached to the tooth 102, while the opposing inter-tooth surfaces 201c are shaped or clipped to enclose the permanent tooth 102 at a height of about half the distance above or towards the contact points between adjacent teeth 102. For purposes of illustration, while this embodiment has been described with reference to the metal cap 101 having a buccal surface 201b, a lingual surface 201a, and a pair of opposing inter-tooth surfaces 201c for a typical molar tooth 102, it is to be understood that the metal cap 101 may be configured in any shape and with any number of surfaces 201 in order to conform to the tooth 102 being extracted. For example, the metal cap 101 may be configured in a closed parabolic shape to conform to an incisor tooth 102 of the patient.

In the embodiment disclosed in the detailed description of FIGS. 3A-3C, the apical strip and loop arrangement 101f may not be required, since dentists can easily remove the metal cap 101 from the tooth 102. Dental cements are used to fasten the metal cap 101 to the body of the tooth 102. As exemplarily illustrated in FIGS. 3A-3C, the buccal surface 201b and the lingual surface 201a can be fastened to the body of the tooth 102 with dental forceps before the dental cement sets hard.

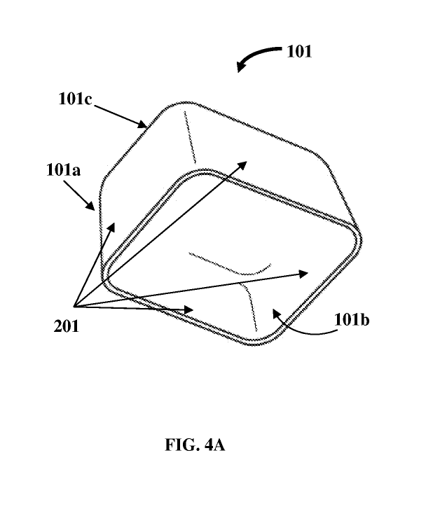

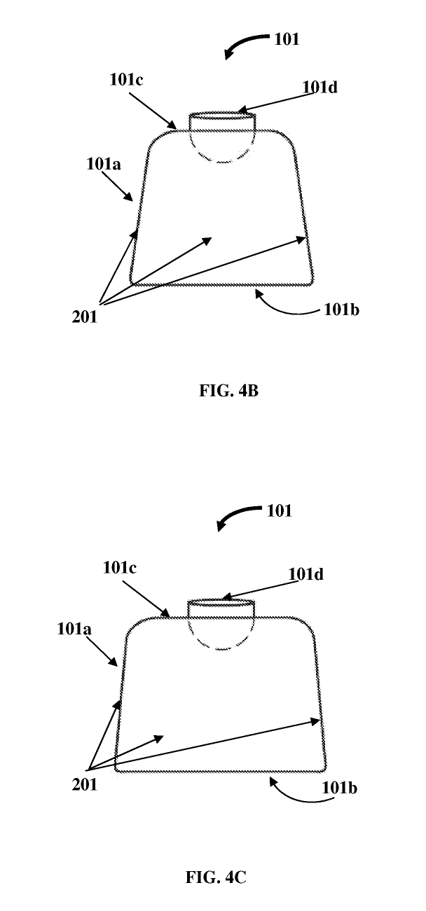

FIG. 4A exemplarily illustrates a bottom perspective view of another embodiment of the metal cap 101. FIG. 4B exemplarily illustrates a side elevation view of this other embodiment of the metal cap 101. FIG. 4C illustrates a front elevation view of this other embodiment of the metal cap 101. In this embodiment, the length of the generally contiguous vertical surfaces 201 of the body section 101a of the metal cap 101 is configured to enclose half the length of the tooth 102 towards the gum line 105 of the patient, when the metal cap 101 is removably attached to the tooth 102. In this embodiment, the metal cap 101 is made of a rigid metal, for example, stainless steel. Enclosing only the top half of the tooth 102 enables easy removal of the metal cap 101 at the end of the tooth removal procedure or the tooth loosening procedure.

A child has 20 primary baby teeth, and all are shaped differently from each other. Although baby teeth for different children may vary slightly in size, the shape is remarkably similar in children of all races. The removable metal cap 101 is custom made for each type of teeth. The metal caps 101 can be sold as a complete set for the entire dentition or for an individual tooth 102. The metal caps 101 are for single use and disposable. Instructions with pictures or video may assist parents to identify the correct metal cap 101 for each tooth 102.

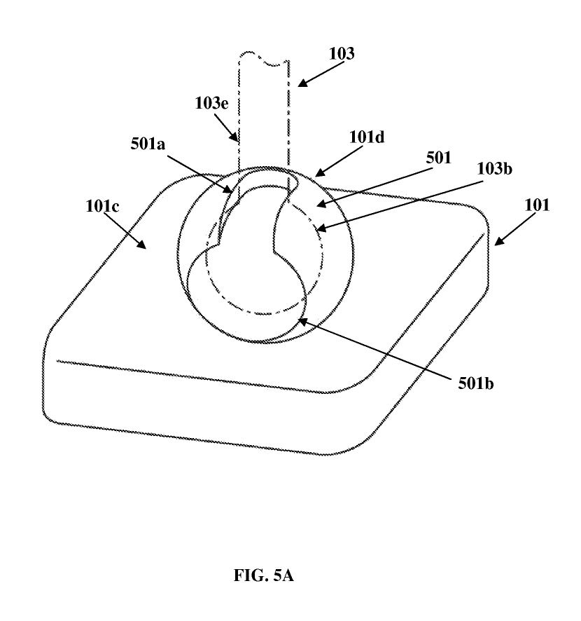

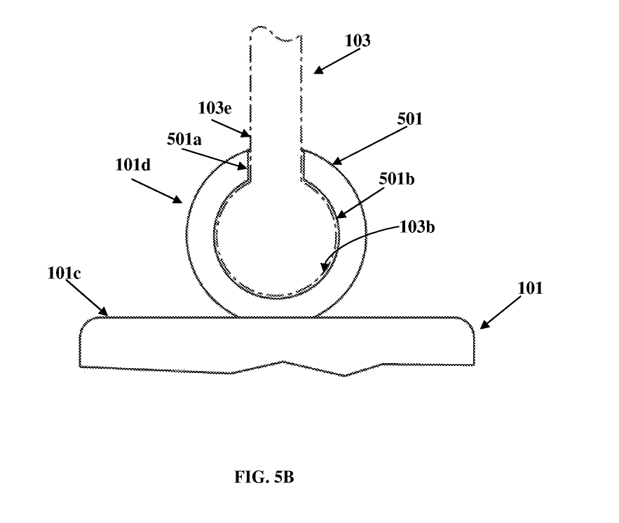

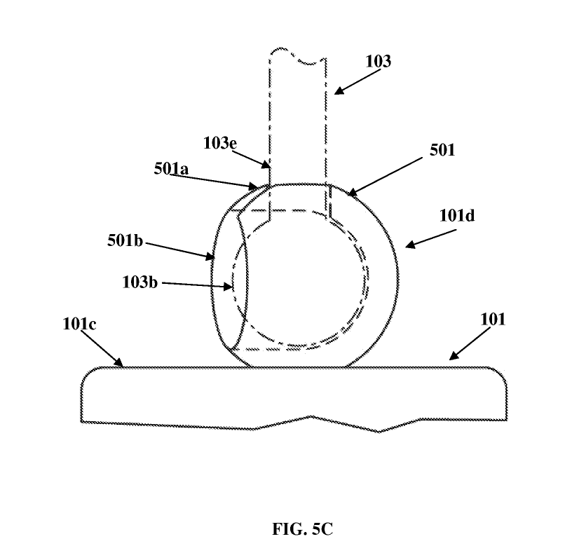

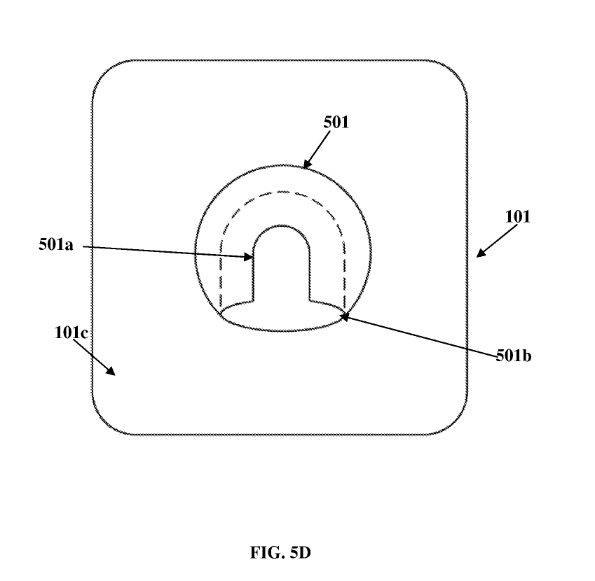

FIG. 5A exemplarily illustrates a partial perspective view of an embodiment of the ball socket 101d of the metal cap 101. FIG. 5B exemplarily illustrates a partial front elevation view of the embodiment of the ball socket 101d. FIG. 5C exemplarily illustrates a partial side elevation view of this embodiment of the ball socket 101d. FIG. 5D exemplarily illustrates a top view of this embodiment of the ball socket 101d. In this embodiment, the ball socket 101d is an enclosed socket or shell 501 all the way around with a slot 501a opening from the top and a circular opening 501b from the side. The enclosed shell 501 allows application of a significant pull force to pull the tooth 102 vertically from the alveolar bone socket 104. The rectilinear slot 501a is wide enough to allow the neck 103e of the ball projection 103b into the ball socket 101d but is narrower than the ball projection 103b. The circular opening 501b is wide enough to allow the ball projection 103b to fit inside the enclosed shell 501. In this manner, once the ball projection 103b is inserted from the circular opening 501b with the neck 103e passed into the slot 501a, the ball projection 103b is locked inside the enclosed shell 501. If the ball projection 103b is pulled from the top, the slot 501a blocks the ball projection 103b inside the enclosed shell 501, thus producing a pull force on the ball socket 101d. This type of metal cap 101 is made, for example, using stainless steel, and can be sterilized for reuse.

FIG. 6A exemplarily illustrates a side view of a transducer assembly 103 of the apparatus 100, showing a ball projection 103b extending from a transducer head 103a of the transducer assembly 103 in a linear configuration. The transducer assembly 103 comprises a ball projection 103b extending from the transducer head 103a through the neck 103e of the ball projection 103b, a transducer head 103a, a trigger button 103d, and a battery compartment 103c. The ball projection 103b engages with the ball socket 101d on top of the removable metal cap 101 as exemplarily illustrated in FIG. 1B. The transducer head 103a produces the vibrations in the ball projection 103b at high frequencies that does not cause pain and discomfort to the tooth 102 being extracted. The trigger button 103d has, for example, high, low, and off options. An AA battery 103f, exemplarily illustrated in FIG. 1A, can be used in the battery compartment 103c to power the transducer assembly 103. People's tolerance to the frequency and magnitude of forces that can be applied on their teeth varies. The frequencies selected in the transducer assembly 103 and applied to the tooth 102 can be selected to be sedative and cause minimal discomfort. Modes of frequencies can be selected by using the trigger button 103d.

In an embodiment, the ball projection 103b of the transducer assembly 103 can be curved as exemplarily illustrated FIG. 6B. FIG. 6B exemplarily illustrates a side view of the transducer assembly 103 of the apparatus 100, showing the ball projection 103b extending from the transducer head 103a of the transducer assembly 103 in a curved configuration. In another embodiment, the ball projection 103b of the transducer assembly 103 can be angled as exemplarily illustrated in FIG. 6C. FIG. 6C exemplarily illustrates a side view of the transducer assembly 103 of the apparatus 100, showing the ball projection 103b extending from the transducer head 103a of the transducer assembly 103 in an angled configuration. The ball projection 103b can be used with all types of teeth 102. During the tooth removal procedure or the tooth loosening procedure, the ball projection 103b does not come in direct contact with the tooth 102 and can be used repetitively for subsequent removal or loosening of teeth. The ball projection 103b may need to be disinfected for reuse but not necessarily sterilized.

During normal chewing of food, the downwards and sideways forces exerted on the tooth 102 do not cause pain. However, if the tooth 102 is already loose or infected and is tender to touch, the tooth 102 should be examined by a dentist. In the absence of an infection, the only source of pain and discomfort would be forces that pull the tooth 102 away from the gum. The half open ball socket 101d disposed on the coronal surface 101c of the removable metal cap 101 is open at the front and the top, and allows the insertion of the ball projection 103b of the transducer assembly 103 into the ball socket 101d from the front. During a tooth removal procedure or a tooth loosening procedure, the ball projection 103b does not apply any pull force on the metal cap 101, since the metal cap 101 is open on the top. The only forces applied by the ball projection 103b to the metal cap 101, are downwards and sideways forces that are transmitted to the metal cap 101. Due to the small magnitude and high frequency of the forces applied by the ball projection 103b to the metal cap 101, the discomfort level would be similar to using an electrically operated tooth brush when cleaning teeth. Parents may expose the children to the vibration of an electrically operated tooth brush before the tooth removal procedure or the tooth loosening procedure to ensure them that the tooth removal procedure or the tooth loosening procedure will be similar to using the electrically operated tooth brush and comfortable.

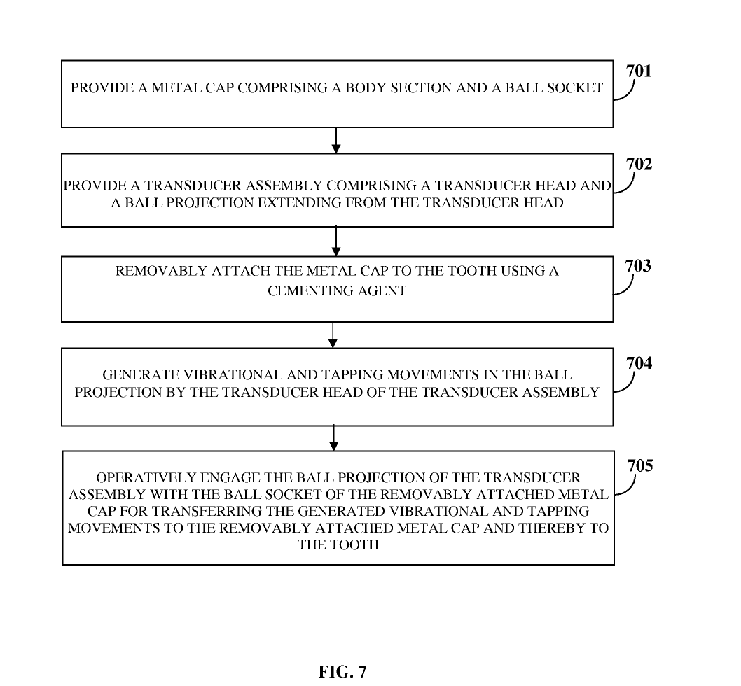

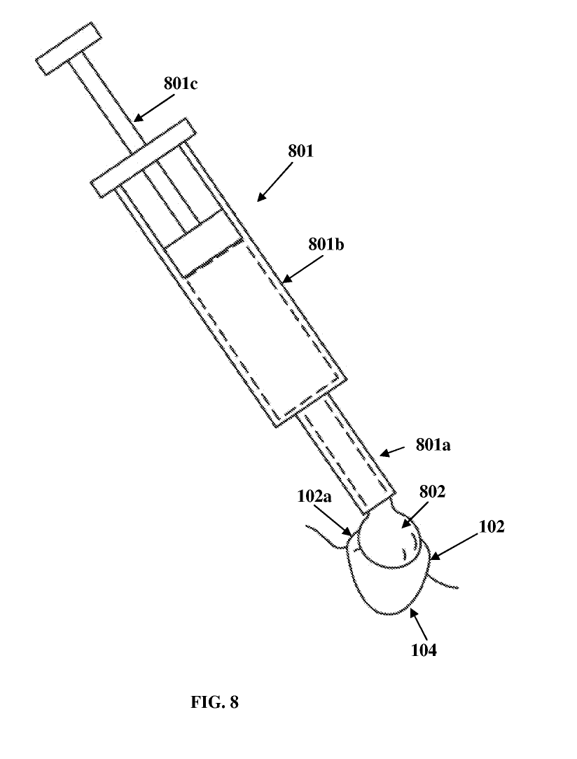

FIG. 7 exemplarily illustrates a method for rupturing connective tissues that attach a tooth 102 to an alveolar bone socket 104 of a patient. A metal cap 101 generally shaped like a crown 102a of the tooth 102, as disclosed in the detailed description of FIGS. 1A-2C, is provided 701. A transducer assembly 103 comprising a transducer head 103a and a ball projection 103b, as disclosed in the detailed description of FIGS. 1A-1B and FIGS. 6A-6C, is provided 702. The metal cap 101 is removably attached 703 to the tooth 102 using a cementing agent. The transducer head 103a is activated to generate 704 vibrational and tapping movements in the ball projection 103b at a predetermined frequency, for example, of about 45 kHz. During a tooth removal procedure or a tooth loosening procedure, the ball projection 103b of the transducer assembly 103 is operatively engaged 705 with the ball socket 101d of the removably attached metal cap 101 for transferring the generated vibrational and tapping movements to the removably attached metal cap 101 and thereby to the tooth 102. The vibrational and tapping movements transferred to the tooth 102 by the transducer assembly 103 ruptures the connective tissues that attach the tooth 102 to the alveolar bone socket 104 of the patient thereby allowing the tooth 102 to be removed from the alveolar bone socket 104 with minimal pull force.

FIG. 8 exemplarily illustrates application of a cementing agent 802 on a tooth 102 using a mixing syringe 801. The mixing syringe 801 comprises a mixing tip 801a, a syringe cartridge 801b, and a syringe handle 801c. The cementing agent 802, for example, cement used herein is rigid and biologically safe for intra oral use. Many dental cement agents or materials can be used for cementing the metal cap 101 to the tooth 102. Most cementing agents require mixing of two fluidic materials in the mixing syringe 801 to form a rigid material. The mixing tip 801a is attached to the syringe cartridge 801b, for example, by a slide and twist-lock mechanism. When the syringe handle 801c is advanced forward, the cementing agent 802 is mixed through the mixing tip 801a. The mixing syringe 801 is used to load the mixed cementing agent 802 onto the primary tooth 102 and/or an inner surface of the removable metal cap 101, and the metal cap 101 is positioned over the primary tooth 102. The cementing agent 802 typically takes, for example, about two minutes to become rigid after application of the cementing agent 802 over the primary tooth 102. At the completion of the tooth removal procedure or the tooth loosening procedure, the apical strip and loop arrangement 101f of the metal cap 101 is severed at the soldered seal 203 exemplarily illustrated in FIG. 2A, to easily remove the soft metal cap 101 from the primary tooth 102. Since the primary tooth 102 is already loose, the removable metal cap 101 can generally be fitted easily over the tooth 102. The patient may be advised to fit the metal cap 101 over the tooth 102 without the cementing agent 802 first to ensure a smooth and accurate cementation. The method and apparatus 100 disclosed herein generally dislodges the tooth 102 from the alveolar bone socket 104 in a few minutes. If the patient experiences bleeding, the patient may be advised to bite on a sterile gauge or a tea bag to control the bleeding. An entire set of removable metal caps 101 for all types of primary teeth 102 may be made available over the counter. Representative pictures and videos can be used to help the patient or an operator to identify the correct matching removable metal cap 101 for the tooth 102 to be extracted.

Consider an example where a child patient has a loose primary molar tooth 102 that needs to be extracted. An adult user, for example, the parent of the patient selects a metal cap 101, as exemplarily illustrated in FIGS. 1A-2C, which matches the primary molar tooth 102. The user then applies the cementing agent 802, for example, a dental cement, either on the inner surface of the metal cap 101 or on the primary tooth 102 using the mixing syringe 801 as disclosed in the detailed description of FIG. 8. Before the cementing agent 802 becomes rigid, the user positions the metal cap 101 on the primary tooth 102 and allows the cementing agent 802 to set. After a few minutes, the adult user sets the transducer assembly 103 to a desired vibrational frequency mode, for example a frequency of about 45 kHz using the trigger button 103d of the transducer assembly 103, and engages the ball projection 103b of the transducer assembly 103 with the ball socket 101d disposed on the coronal surface 101c of the cemented metal cap 101 in situ inside the oral cavity of the patient. The user then powers the transducer assembly 103 to generate and transfer the vibrational and tapping movements at the desired frequency and force to the metal cap 101 through the ball projection-ball socket engagement, and in turn to the tooth 102 enclosed by the metal cap 101. At this point, the connective tissues, for example, the periodontal ligaments begin to rupture and within a few minutes the primary tooth 102 falls out of the alveolar bone socket 104 of the child patient. At the end of the procedure, the adult user can either lift the metal cap 101 directly from the front edge of the apical strip and loop arrangement 101f, or cut open the soldered seal 203 of the apical strip and loop arrangement 101f with a scissor. The apical strip and loop arrangement 101f is soldered together at the apical edge 202 to strengthen the integrity of the metal cap 101. The soldered seal 203 is not very strong and can be severed by applying a mild shearing force.

Although there may be difficulties for an inexperienced user to learn usage of the apparatus 100 disclosed herein, the benefit of overcoming weeks of discomfort and possibly avoiding the cost of visiting a dental office is a good incentive for a parent or an adult user to learn its usage. The method and apparatus 100 disclosed herein poses minimal risk to both the operator and the patient. In case of a failed attempt in removing the tooth 102, the soft nature of the metal cap 101 does not cause any health risk to the child patient. The apparatus 100 disclosed herein may be used by a layperson or a dentist for removing primary teeth and for loosening permanent teeth.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. An apparatus for rupturing connective tissues that attach a tooth to an alveolar bone socket, comprising:
a metal cap generally shaped like a crown of said tooth, wherein said metal cap is removably attached to said tooth using a cementing agent, said metal cap comprising:
a body section, said body section comprising a coronal surface and a plurality of generally contiguous vertical surfaces that define a hollow space within said body section for enclosing said tooth, wherein at least one of said one or more generally contiguous vertical surfaces comprises a slit terminating with an apical strip and loop arrangement; and
a ball socket extending from said coronal surface of said body section; and
a transducer assembly comprising a transducer head and a ball projection extending from said transducer head, said transducer head configured to generate vibrational and tapping movements in said ball projection, wherein said ball projection is configured to operatively engage said ball socket of said metal cap to transfer said generated vibrational and tapping movements to said removably attached metal cap and thereby to said tooth;
whereby said vibrational and tapping movements transferred to said tooth by said transducer assembly ruptures said connective tissues that attach said tooth to said alveolar bone socket to allow said tooth to be removed from said alveolar bone socket.

2. The apparatus of claim 1, wherein said apical strip and loop arrangement of said body section of said metal cap secures said metal cap to said tooth, wherein said apical strip and loop arrangement is severed open to remove said metal cap from said tooth.

3. The apparatus of claim 1, wherein said apical strip and loop arrangement of said body section of said metal cap is configured as a fold in an apical edge of said body section, wherein said apical edge of said body section is soldered at a neck of said fold to form a seal.

4. The apparatus of claim 1, wherein said ball projection extends from said transducer head of said transducer assembly in one of a linear configuration, a curved configuration, and an angled configuration.

5. The apparatus of claim 1, wherein said one or more generally contiguous vertical surfaces of said body section of said metal cap are configured to enclose half a length of said tooth towards a gum line, when said metal cap is removably attached to said tooth.

6. The apparatus of claim 1, wherein said one or more generally contiguous vertical surfaces of said body section of said metal cap comprise a buccal surface, a lingual surface, and a pair of opposing inter-tooth surfaces, wherein said buccal surface and said lingual surface are configured to enclose said tooth up to a gum line when said metal cap is removably attached to said tooth, and wherein said pair of said opposing inter-tooth surfaces is configured to enclose said tooth at half a distance above contact points with adjacent teeth.

7. The apparatus of claim 1, wherein said cementing agent comprises a rigid, biologically safe, and quick setting dental cement that secures said metal cap firmly to said tooth.

8. The apparatus of claim 1, wherein said metal cap is made of one of a soft metal alloy and a rigid metal, and shaped to custom fit each type of primary teeth up to a gum line.

9. The apparatus of claim 1, wherein said transducer head is configured to generate said vibrational and tapping movements at a predetermined frequency, said predetermined frequency of said vibrational and tapping movements causing minimal pain and discomfort to a patient.

10. The apparatus of claim 1, wherein said ball socket is an enclosed shell that produces a pull force to pull said tooth vertically from said alveolar bone socket, wherein said ball projection is inserted into said ball socket from a side and locked inside said ball socket.

11. A method for rupturing connective tissues that attach a tooth to an alveolar bone socket, comprising:
providing a metal cap generally shaped like a crown of said tooth, said metal cap comprising:
a body section, said body section comprising a coronal surface and a plurality of generally contiguous vertical surfaces that define a hollow space within said body section for enclosing said tooth, wherein at least one of said one or more generally contiguous vertical surfaces comprises a slit terminating with an apical strip and loop arrangement; and
a ball socket extending from said coronal surface of said body section;
providing a transducer assembly comprising a transducer head and a ball projection extending from said transducer head;
removably attaching said metal cap to said tooth using a cementing agent;
generating vibrational and tapping movements in said ball projection by said transducer head of said transducer assembly; and
operatively engaging said ball projection of said transducer assembly with said ball socket of said removably attached metal cap for transferring said generated vibrational and tapping movements to said removably attached metal cap and thereby to said tooth;
whereby said vibrational and tapping movements transferred to said tooth by said transducer assembly ruptures said connective tissues that attach said tooth to said alveolar bone socket to allow said tooth to be removed from said alveolar bone socket.

12. The method of claim 11, wherein said apical strip and loop arrangement of said body section of said metal cap secures said metal cap to said tooth, wherein said apical strip and loop arrangement is severed open to remove said metal cap from said tooth.

13. The method of claim 11, wherein said apical strip and loop arrangement of said body section of said metal cap is configured as a fold in an apical edge of said body section, wherein said apical edge of said body section is soldered at a neck of said fold to form a seal.

14. The method of claim 11, wherein said ball projection extends from said transducer head of said transducer assembly in one of a linear configuration, a curved configuration, and an angled configuration.

15. The method of claim 11, wherein said one or more generally contiguous vertical surfaces of said body section of said metal cap are configured to enclose half a length of said tooth towards a gum line, when said metal cap is removably attached to said tooth.

16. The method of claim 11, wherein said one or more generally contiguous vertical surfaces of said body section of said metal cap comprise a buccal surface, a lingual surface, and a pair of opposing inter-tooth surfaces, wherein said buccal surface and said lingual surface are configured to enclose said tooth up to a gum line when said metal cap is removably attached to said tooth, and wherein said pair of said opposing inter-tooth surfaces is configured to enclose said tooth at half a distance above contact points between adjacent teeth.

17. The method of claim 11, wherein said cementing agent comprises a rigid, biologically safe, and quick setting dental cement that secures said metal cap firmly to said tooth.

18. The method of claim 11, wherein said metal cap is made of one of a soft metal alloy and a rigid metal, and shaped to custom fit each type of primary teeth up to a gum line.

19. The method of claim 11, wherein said transducer head generates said vibrational and tapping movements at a predetermined frequency, said predetermined frequency of said vibrational and tapping movements causing minimal pain and discomfort to a patient.

20. The method of claim 11, wherein said ball socket is an enclosed shell that produces a pull force to pull said tooth vertically from said alveolar bone socket, wherein said ball projection is inserted into said ball socket from a side and locked inside said ball socket.
